(19) United States
(12) Patent Application Publication
(10) Pub. No.: US 2010/0070865 A1
(43) Pub. Date: Mar. 18, 2010

(54) METHOD FOR PROVIDING A SERVICE TO UPLOAD AND DISCLOSE CRITICIZING OPINIONS ABOUT CRITICIZING TARGETS

(76) Inventors: Sang Hoon Kim, Seoul (KR); Chao-Soe Park, Seoul (KR)

Correspondence Address: REED SMITH LLP, 3110 FAIRVIEW PARK DRIVE, SUIT 1400, FALLS CHURCH, VA, 22042, US

(21) Appl. No.: 12/312,964

(22) PCT Filed: Dec. 11, 2007
(86) PCT No.: PCT/KR2007/006444

§ 371 Date: Jun. 2, 2009

(30) Foreign Application Priority Data
Dec. 13, 2006 (KR) 10-2006-0127005

(51) Int. Cl. G06F 3/01

(52) U.S. Cl. 715/733; 715/810

(57) ABSTRACT

The present invention discloses a method for providing a service to upload and disclose criticizing opinions about criticizing targets. The method allows a web server to provide, on-line, a web screen that includes a list configured by classifying a plurality of criticizing targets into a main group wherein the criticizing targets are divided every category and a sub-group wherein the criticizing targets in the main group are subdivided into more than one step every category. An upload of criticizing opinions about various criticizing targets and a disclosure about criticizing opinions uploaded by other persons can be performed on one web site by providing a web site collecting various criticizing targets on a web.

### TECHNICAL FIELD

The present invention relates to a method for providing a service to upload and disclose criticizing opinions about criticizing targets.

### BACKGROUND ART

As an information communication means such as an internet is developed, various opinions from all sorts of people are easily expressed and spread on-line. One such phenomenon, an anti site has been activated. The anti site is a site created to collect and share criticizing opinions about criticizing targets such as specific persons or companies or specific products or services, etc. For example, when a person with a criticizing view about specific products or services establishes an anti site about the corresponding products, the anti site permits people to sympathize with his opinion and to upload criticizing opinions about the corresponding products or services and others to disclose them. Others can recognize the defects or complaints of the corresponding products through the criticizing opinions uploaded on such an anti site as well as obtain information on the corresponding products through the anti site.

However, since all the anti sites currently established on the internet are established individually, they are configured to upload the criticizing opinions only about one criticizing target. For example, if any one of netizens establishes the anti site about specific products or services in a manner of a personal home-page, others upload the criticizing opinions on the anti site. Therefore, the criticizing target may be limited only to the target designated by the netizen establishing the anti site so that others can upload the criticizing opinions about the designated target. In such a manner, positive opinions and negative opinions about the corresponding products are scattered over various paths such as a home-page of a specific product, portal sites, on-line clubs, or Internet shopping malls, etc.

Therefore, since there are several anti sites about the same criticizing target in such an existing manner, when the general public wants to disclose the criticizing opinions about their desired criticizing targets, they feel the inconvenience of searching several sites and then disclosing the criticizing opinions and do not collect unified opinions through one anti site so that they can construe opinions about the same product differently.

Furthermore, if the general public does not find an anti site about his/her desired criticizing target, he/she should establish an anti site by himself/herself. This requires at least knowledge and cost to establish an individual home page so it is difficult for the general public to upload the criticizing opinions.

Meanwhile, such an anti site has a right function and a reverse function, respectively. The right function is to share information on the defect of the specific product so that the general public may refer to a judgment of an actual user about the specific product, not a judgment based on an advertisement of a product seller. The reverse function is to defame the reputation of the specific product or service due to a groundless libel or rumor thereon. Such a reverse function is mainly caused by reliability of opinions uploaded on an anti site, more specifically by an incomplete real name authentication of persons uploading criticizing opinions as all the anti sites are operated individually or on a small scale. There is much possibility of the groundless libel or rumor or defamation of character on the corresponding product or service due to the incomplete real name authentication.

Also, the company providing the corresponding product or service hires a person uploading reply opinions against the criticizing opinions as the real name is not authenticated so that it emphasizes only the right function of its products or services, etc., to calm down or mitigate the criticizing opinions.

Therefore, the general public disclosing the criticizing opinions comes in contact with the various opinions uploaded without having any apparatus capable of discerning truth or falsehood of the criticizing opinions. If there is any apparatus capable of discerning truth or falsehood of the criticizing opinions, the problems of the defamation of character or the groundless libel can be reduced and the attempts intending to mitigate the criticizing opinions can also be prevented so that sound critical culture can be formed with the help of the opinions reliable by the general public. However, there is almost no a possibility that the anti sites are used as a place of sound criticism and information exchange in the reality of a random establishment of the anti sites and an upload of the criticizing opinions that do not have a reliable ground so they have a large possibility to lead to social problems.

### DISCLOSURE

### Technical Problem

The present invention proposes to solve the problems. It is a first object of the present invention to provide a web site integrating various criticizing targets on a web to supplement problems due to sporadic activity caused by the individual establishment of anti sites by means of a general netizen so that the general public can integrally perform an upload of criticizing opinions about his/her desired criticizing targets and a disclosure about criticizing opinions uploaded by other persons on one web site.

It is a second object of the present invention to allow a user to easily add specific targets as criticizing targets even when there is not an anti site about his/her desired criticizing targets on a web, making it possible to easily obtain the substantially same effect as an establishment of a new anti site.

It is a third object of the present invention to minimize a possibility of leading to social problems such as defamation of character due to groundless libel or rumor unproven that is existing in anti sites and prevent an attempt intending to mitigate criticizing opinions about criticizing targets to assure truth of criticizing opinions while performing an information exchange of criticizing opinions about specific targets, making it possible to form sound critical culture.

### Technical Solution

In order to accomplish the above objects, the present invention provides a method for providing a service to upload and disclose criticizing opinions about criticizing targets, the method comprises the steps of: (a) allowing a web server to provide, via on-line, a web screen that includes a list configured by classifying a plurality of criticizing targets into a main group wherein the criticizing targets are divided every category and a sub-group wherein the criticizing targets in the main group are subdivided into more than one step every category; (b) allowing the web server to provide a screen uploading criticizing opinions about the criticizing targets selected to user computers, according to a transfer of selection instructions on the respective criticizing targets within the sub group from the user computers to the web server; (c) allowing the web server to store the criticizing opinions corresponding to the criticizing targets, according to an upload of the criticizing opinions about the criticizing targets by means of the user computers; and (d) allowing the web server to provide the criticizing opinions about the criticizing targets to the predetermined computers on-line, according to a transfer of a disclosure request of the criticizing opinions about the criticizing targets from the predetermined computers to the web server.

If the predetermined computers disclosing the criticizing opinions in step (d) transfer declaration of intention for and against the criticizing opinions to the web server, the web server stores the declaration of intention for and against the criticizing opinions to provide it on-line according to the disclosure requests from other inquirers.

The web server receives personal information on users of the user computer to authenticate their real names based on the personal information and in this step (d), it provides the user real names together with the criticizing opinions.

Only a portion of the real name can be displayed and a portion of the personal information together with the entire or a portion of the real name can also be displayed. Furthermore, in step (d) the real name of the user as well as a fact that the real name is true is displayed.

The web server transfers the criticizing opinions about the criticizing targets to an address on-line, which is designated by the criticizing targets.

The web server gives a predetermined manager ID to a manager of the criticizing targets through a previous authentication thereof and in step (d), displays a fact that the opinions uploaded through the manager ID are written by the manager. When the reply opinions of the manager are uploaded through the manager ID, the web server transfers whether the reply opinions of the manager are uploaded and/or the contents of the reply opinions of the manager to an opinion writer for criticizing via e-mail or SMS using a cellular phone number of the writer.

The web server establishes the specific targets as the criticizing targets within the sub group according to a reception of an additional request about the specific targets within the sub group from the user computer.

Meanwhile, the web server collects, on the web, the criticizing opinions uploaded on other anti sites thereon to store the collected criticizing opinions corresponding to the criticizing targets and in step (d), provides the collected criticizing opinions. At this time, the web server may collect the criticizing opinions using a RSS reader.

### Advantageous Effects

The present invention can perform an upload of criticizing opinions about various criticizing targets and a disclosure about criticizing opinions uploaded by other persons on one web site by providing a web site integrating various criticizing targets on a web.

Also, the present invention can easily add specific criticizing targets so as to upload criticizing opinions thereabout even when there are no anti sites about user desired criticizing targets on a web.

Furthermore, the present invention can post a real name of a person uploading the criticizing opinions to increase reliability of criticizing opinions so that a possibility of leading to social problems such as defamation of character due to groundless libel or rumor is minimized, making it possible to contribute to a formation of sound critical culture by means of a substantial information exchange through anti sites.

Moreover, the present invention unifies official reply channels about criticizing opinions to easily disclose criticizing opinions and an explanation therefore through the one channel in view of a position of the netizen or the company and when affirmative opinions against the criticizing opinions are uploaded, identifies whether the official explanation for the criticizing opinions is made by the official subject to obtain a reliable reply opinions.

### BRIEF DESCRIPTION OF THE DRAWINGS

These and other objects, features, aspects, and advantages of preferred embodiments of the present invention will be more fully described in the following detailed description, taken in conjunction with the accompanying drawings. In the drawings:

FIG. 1 is a schematic view of a system for providing a service to upload and disclose criticizing opinions according to the present invention;

FIG. 2 is a view showing a process for providing a service to upload and disclose criticizing opinions performed by the system of FIG. 1; and

FIGS. 3 to 6 are exemplification views of a web screen provided by a web server in the entire process of FIG. 2.

### BEST MODE FOR CARRYING OUT THE INVENTION

Hereinafter, the embodiments of the present invention will be described in detail with reference to the accompanying drawings.

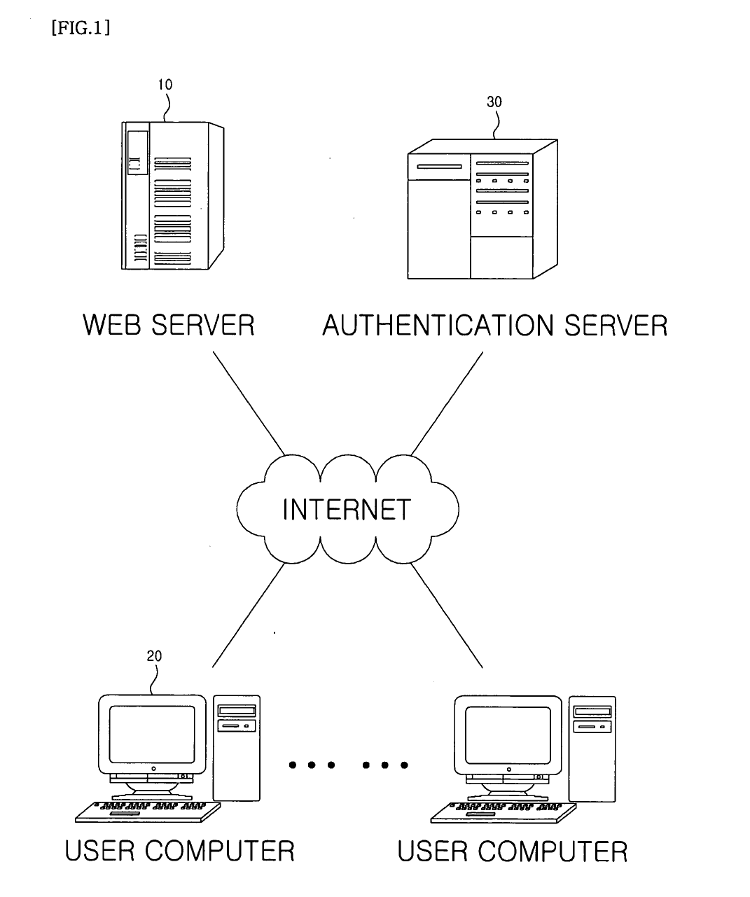

FIG. 1 is a schematic view of a system for providing a service to upload and disclose criticizing opinions according to the present invention.

The system for providing a service to upload and disclose criticizing opinions according to the present invention comprises a web server 10, a user computer 20, and an authenticating server 30 that are connected to communicate data to each other on an internet.

The web server 10, which is a sever performing a core function of the present invention, provides a web site uploading criticizing opinions on-line such as the internet to receive and store the criticizing opinions from the user computer 20 (to this end, the web server 10 includes a database or a server for building a separate database) and to disclose them on the internet according to a request from another user computer 20.

The authenticating server 30 performs a function of authenticating a real name of a person subscribed as a member to the web server 10 according to a request from the web server 10. The user computer 20 is used by users uploading the criticizing opinions or disclosing the criticizing opinions uploaded on the web server 10 by accessing the web server 10.

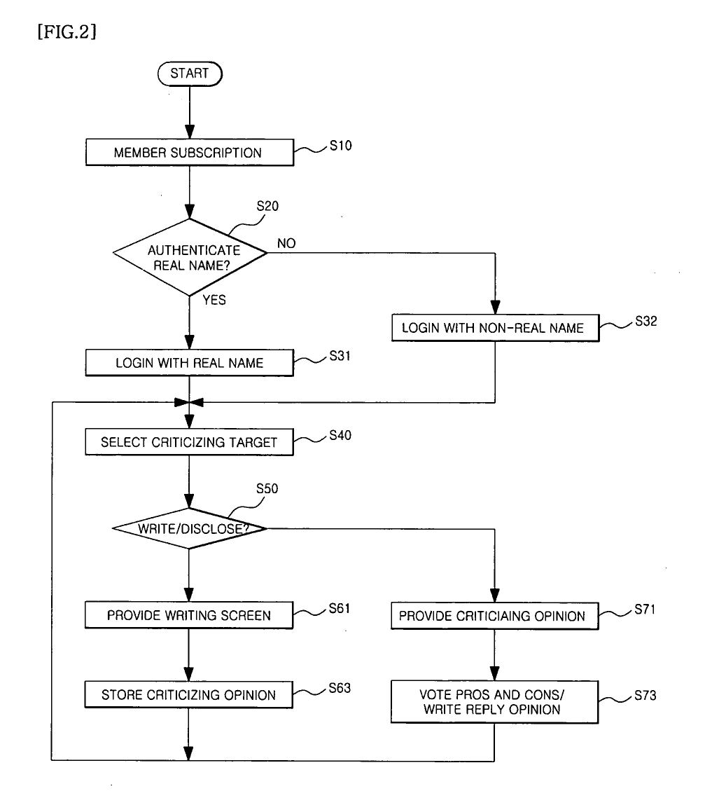

FIG. 2 is a view showing a process for providing a service to upload and disclose criticizing opinions performed by the system of FIG. 1.

First, a user inputs his/her personal information to the web server 10 to perform a member subscription so that he/she is given authority to upload or disclose opinions on the web site provided by the web server 10.

The web server 10 requests authentication for the personal information input at the time of the member subscription to the authenticating server 30 to perform a real name authentication (S20). A method for authenticating a real name is not restricted. In other words, various methods can be adopted, such as, the authentication of the real name may be performed according to whether a resident registration number conforms to a name and be performed according to whether a cellular phone number conforms to a name by disclosing a database of a mobile communication company, after confirming whether the user has the cellular phone by asking the input of the cellular phone number of the user and sending an authenticating number to the user via a SMS and then allowing the user to input this authenticating number to the web server 10, etc.

Such a procedure of the real name authentication may be omitted, if necessary. When the member whose real name is authenticated uploads the criticizing opinions later, its real name is displayed so that he/she uploads the opinions based on the truth, making it possible to increase reliability of the criticizing opinions. Furthermore, the procedure of the member subscription may be omitted. In this case, an unsubscribed member or a member whose real name is not authenticated cannot freely upload the criticizing opinions and is permitted only to disclose the criticizing opinions or is not permitted even to disclose them. The member whose real name is authenticated can perform the login in the web server 10 through the real name later (S31), but the member whose real name or the unsubscribed member is not authenticated can be logged in via an unreal name through an issue of a temporary ID or a user selection of a temporary ID, etc (S32).

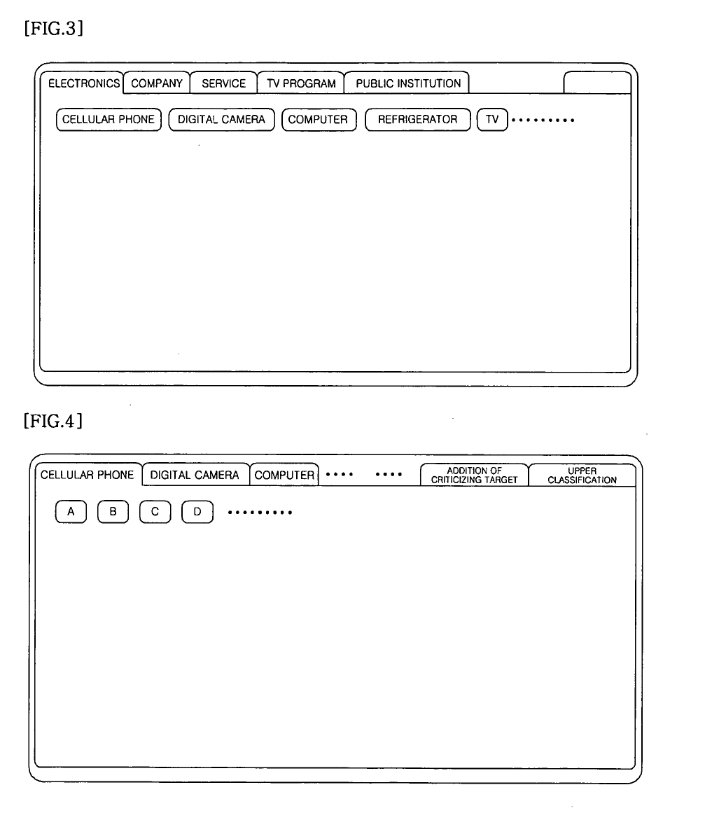

The user accessing the web site provided by the web server 10 selects the criticizing targets using the user computer 20 (S40). To this end, the web server 10 first provides the web screen such as FIG. 3 to the accessed user computer 20. Referring first to FIG. 3, a main screen of the web site is provided with a list of the criticizing targets. The list of the criticizing targets is configured by classifying a plurality of criticizing targets into a main group wherein the criticizing targets are divided every category and a sub-group wherein the criticizing targets in the main group are subdivided into more than one step every category. In FIG. 3, there is shown a menu divided such as a group of electronics, companies, services, TV programs, public institutions, etc., as a main group.

If the user selects any one item within such a main group, for example, electronics, the sub group such as a cellular phone, a digital camera, a computer, a refrigerator, a TV, etc., as the sub group within the main group called the electronics is displayed. If the cellular phone is selected within such a sub group, model names of each cellular phone, that is, A, B, C etc., are displayed on the screen as shown in FIG. 4. The products specified by each model name become the criticizing targets. The sub group within the main group may be divided into more steps.

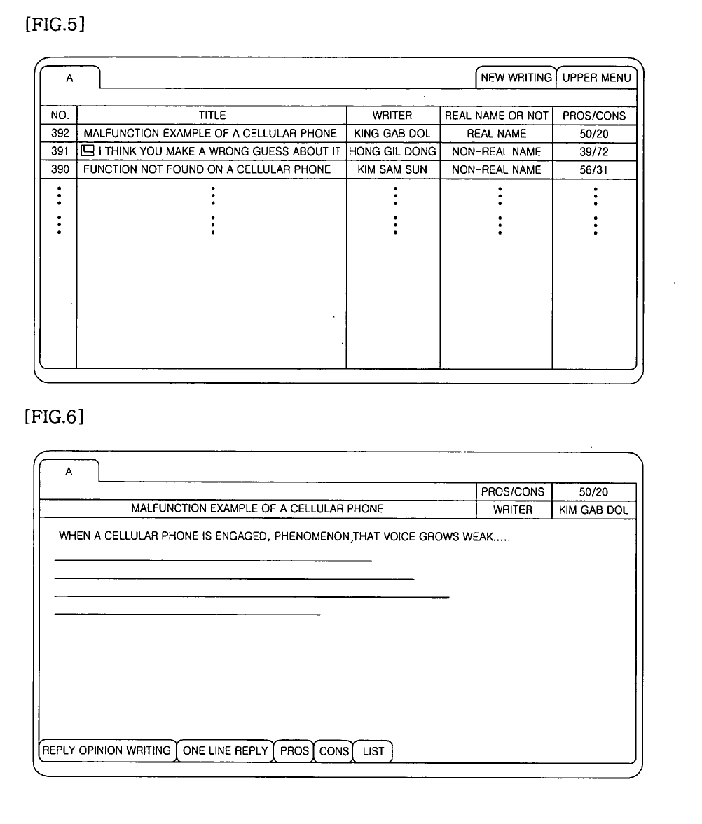

The final criticizing target subjected to the main menu and the sub menu is selected by choosing any one from the list of the criticizing targets. If the criticizing target is selected and then clicked, the screen as shown in FIG. 5 is provided to the user computer 20 by the web server 10 for display. FIG. 5 shows a state where various criticizing opinions and reply opinions thereon are previously uploaded.

Reviewing a screen configuration of an A cellular phone, contents such as a number of opinions, a title of an opinion, a writer, a real name or not, and a situation of pros and cons, etc and a new writing icon are provided on the web screen. The user clicks the new writing icon or selects and clicks specific writings so that he/she can disclose the new opinions or the existing opinions (S50). Meanwhile, an upper menu icon is provided on the screen of FIG. 5. When this upper menu icon is clicked, the web screen is moved to the upper group of the corresponding sub group (that is, the sub group called electronics in FIG. 5).

The writer item of FIG. 5 is marked with names (or IDs) of persons uploading the criticizing opinions. At this time, the real name or not item is marked with a real name when the real name of the user is authenticated in S20 and the user does a login with the real name in S31 and otherwise, is marked with non-real name. When displaying such criticizing opinions, a reader can more reliably trust accuracy and truth of the opinions, etc., by displaying both the real name and the fact of being the real name. The item of pros and cons is marked with numerical values on whether the inquirer reading the opinions simply sympathizes with the contents of the opinions, wherein the statistics of the opinions of a plurality of inquirers on the reliability or accuracy of the opinions can be simply appreciated by referring to these numerical values.

In the web screen of FIG. 5 having such a screen configuration, if the number or title of the opinion is clicked, the disclosure screen as shown in FIG. 6 is provided (S71). The user can disclose the concrete contents of the criticizing opinions through this screen. This screen displays the statistics of the pros and cons and the name of the writer and the lower end of the screen displays icons (reply opinions writing, one line reply, pros, cons, list, etc.) with various functions selectable by the inquirer, making it possible to perform the pros and cons or the reply opinions written, and the like (S73). If the reply opinions writing icon are clicked, the reply opinions can be written with the opinions designated by a separate serial number. The results are started as the reply opinions such as the opinion of No. 391 of FIG. 5. If the one line reply is clicked, a screen capable of writing several tens of words of simple reply opinions is provided. If the pros and cons are clicked, the intentions of pros and cons are stored in the web server 10 so that they are reflected in the numbers of the item of the pros and cons. The results are provided on the screen of FIG. 5 when other users disclose them. If the list is clicked, it returns back to the screen providing the list of the criticizing opinions as shown in FIG. 5.

Meanwhile, the new writing icon is clicked in FIG. 5 to select the writing, a usual writing screen is provided (S61) and the user writes the desired opinions on the writing screen, making it possible to upload the criticizing opinions. The web server 10 can store the uploaded opinions (S63) and can provide the criticizing opinions uploaded on the web to allow other inquirers to disclose the newly uploaded opinions.

On the other hand, the present invention provides the upload and disclosure of basic criticizing opinions and further functions (the vote of the pros and cons, the reply opinions written, the display of the real name or not, etc.) accordingly.

As one of the services, the web server 10 suggests services transferring the criticizing opinions about the criticizing targets to the address on-line designated by means of the criticizing targets. This is, for example, a service transferring all the criticizing opinions about a cellular phone A to an IP address or an e-mail address designated by a manufacturer, according to the agreement between the manufacturer of the cellular phone A and the operator of the web server 10. The cellular phone A is selected as the criticizing target on the web server 10 and a person in charge of the manufacturer of the cellular phone A discloses the criticizing opinions uploaded about the criticizing target so that he can monitor the criticizing opinions uploaded about the product. Therefore, the person in charge of the manufacturer of the cellular phone A directly accesses the web server 10 to upload the reply opinions so that he can give the explanation for the criticizing opinions or the explanation therefore through the home page of the manufacturer or a press.

At this time, a separate manager ID whose real name is previously authenticated is given to the manufacturer that is a management subject by the operator of the web server 10 and the operator of the web server 10 assures a fact that a person accessing the manager ID is a responsible person in charge of the manufacturer of the cellular phone A. For the assurance, a separate mark (logo or name of company) identifiable by the netizens is given to the manufacturer ID, making it possible to easily appreciate the official reply opinions. With such a method, the official reply opinions for the criticizing opinions about the criticizing targets only by a person that provides the products/services of the criticizing targets can be provided so that the inquirer of the criticizing opinions easily divides the official reply opinions of the company and the reply opinions optionally uploaded by the general public, making it possible to give differentiated reliability to the reply opinions, etc. Also, when there are misunderstandings about the corresponding opinions beyond a unilateral learning of the critical opinions about the cellular phone A, the manufacturer can actively explain it and the netizens can easily appreciate whether there are rapid and active reply opinions or explanation or follow-up measures of the company.

Furthermore, in order to supplement such a function, the screen of FIG. 5 may include marks for various further functions. For example, in addition to fields shown in FIG. 5, a field indicating whether there are the reply opinions of the company about the criticizing opinions is added or a field indicating a required time to post the reply opinions of the company, etc, is added, making it possible to appreciate the measures or countermeasure speed of the company, etc., about consumer complaints.

Also, when the official replay opinions of the company about the specific criticizing opinions are uploaded, the web server 10 may transfer the publication of the reply opinions or not and/or the contents of the reply opinions to the opinion writer for criticizing via e-mail or the SMS.

Furthermore, the present invention provides a function of allowing the general public to add the criticizing targets to the web server 10, as other further functions. For example, when there is no cellular phone of the specific model that the general public wants to make as the criticizing target among the cellular phones that are the criticizing targets previously established within the sub group, the further function newly adds the model name of the cellular phone that is the desired criticizing target to the sub group called cellular phone so that the criticizing targets can be established. For such functions, the screen of FIG. 4 is provided with a criticizing target adding icon. If this icon is clicked, the screen inputting the model name of the cellular phone that the general public wants to add is provided to the user computer 20 by means of the web server 10 and if the user inputs the model name, the web server 10 searches its data base to confirm whether the model name already exists and then, when the model name does not exist, this is established as a new criticizing target. If an addition of the criticizing target is completed, the newly added criticizing target is displayed on the screen of FIG. 4.

Meanwhile, the web server 10 confirms whether it is established as the criticizing target in the cellular phone sub group as well as other sub groups in a process of confirming whether the model name is the already existing model name (criticizing targets). The added specific criticizing target is added to the cellular phone sub group, however, in the case of equipment with a function of a digital camera as a main function, the criticizing target may be classified as the digital camera.

With the existence of such a function, the user can easily add his/her desired criticizing targets only by the operations of clicking the addition of the criticizing target on the web site of the web server 10 and inputting a name so that even when there is no anti site about the user desired criticizing targets on the web, he/she can easily establish the anti site.

Meanwhile, when the criticizing target to be added already exists, the screen of FIG. 5 about the corresponding criticizing target may be immediately provided to the user computer 20.

Preferably, a screen capable of finding the criticizing targets through a search rather than finding them through the menu is included in the screen of FIG. 3. With such a function, for example, if a name called A is searched, a list of the criticizing targets including the name called A is provided and if the corresponding list is clicked, the screen as shown in FIG. 5 is provided.

On the other hand, the display of the real name in the present invention may be achieved by a method of displaying a portion of a real name in addition to a method of displaying a real full name. For example, for a real name called Hong Gil Dong, one character such as Hong Gil * is displayed in a special character or number or an alphabet letter, etc. With such a method, a person with the corresponding real name is displayed and the full name thereof is not exposed so that an effect of the real name can be obtained to some degree as well as the privacy of the writer can be protected.

Also, when the entire name or portion of the real name is published, partial personal information may be published together with the entire name or portion of the real name. For example, when a member called Hong Gil Dong is a man in his 40s, it may be displayed like Hong Gil 14. In the number 14, 1 means man (2 in the case of woman) and 4 means ages (40s). Since the web server 10 receives personal information when the user applies for membership, it can appreciate his/her gender and age. Therefore, a conversion to such a method upon displaying the real name may be automatically performed by the web server 10.

With such methods, a reader may use the personal information of a person uploading the opinions as more reliable judgment data. For example, in the case of the criticizing opinions about services provided by a public institution, the netizens reading the opinions may refer to the personal information as judgment data on reliability of opinions in such a way that is slightly degrading to the reliability of opinions uploaded by teenagers. Also, the criticizing opinions are classified by every gender and age, if necessary, making it possible to select and see only opinions of a specific class. To this end, the screen of FIG. 5 is provided with a section wherein the user can input the search conditions (name, age, and gender of a writer) so that only the opinions meeting the conditions input by the user can be displayed.

As a further function of deciding the ranking of the persons writing the opinions in a high (or low) recognition order and then posting the ranking together with the corresponding criticizing opinions on the web may be added. At this time, the selection of the criticizing opinions with the highest (or lowest) recognition may depend on an order receiving the intentions of many pros from other users.

Meanwhile, the description refers only to the case where the criticizing opinions are uploaded by the user. However, a function of automatically collecting the criticizing opinions that already exist in the existing anti sites may be added. In other words, the criticizing opinions uploaded on the existing anti sites are collected by an RSS reader used as a tool of a web 2.0, wherein the RSS reader is included in the web server 10 and is registered with RSS addresses of sites providing RSS tags among various anti sites already existing on the web. And, the web server 10 accesses each anti site through the RSS reader to collect the criticizing opinions and stores the collected criticizing opinions corresponding to the anti sites. Such stored criticizing opinions are provided to the inquirers with the opinions directly uploaded by the users according to the disclosure requests from other inquirers.

With such a method, both the opinions uploaded on the various existing anti sites and the opinions newly uploaded on other anti sites are collected and posted on the web site by means of the web server 10 of the present invention so that the user can more conveniently use a function of integrating and disclosing the opinions uploaded on various anti sites through the web site.

Meanwhile, the present invention illustrates the opinions as the contents uploaded by the user, but can upload a photograph, a moving picture, or a sound data in addition to the opinions. For example, the user can upload a photograph or a moving picture taking an example of malfunction together with the opinions. One referred to as the criticizing opinions throughout the specification of the present invention should be construed as contents in a broad sense, including such a photograph, moving picture, sound data, etc.

Although a few embodiments of the present invention have been shown and described, it would be appreciated by those skilled in the art that changes might be made in this embodiment without departing from the principles and spirit of the invention, the scope of which is defined in the claims and their equivalents.

1. A method for providing a service to upload and disclose criticizing opinions about criticizing targets, the method comprises the steps of:
(a) allowing a web server to provide, on-line, a web screen that includes a list configured by classifying a plurality of criticizing targets into a main group wherein the criticizing targets are divided every category and a sub-group wherein the criticizing targets in the main group are subdivided into more than one step every category;
(b) allowing the web server to provide a screen uploading criticizing opinions about the criticizing targets selected to user computers, according to a transfer of selection instructions on the respective criticizing targets within the sub group from the user computers to the web server;
(c) allowing the web server to store the criticizing opinions corresponding to the criticizing targets, according to an upload of the criticizing opinions about the criticizing targets by means of the user computers; and
(d) allowing the web server to provide the criticizing opinions about the criticizing targets to the predetermined computers on-line, according to a transfer of a disclosure request of the criticizing opinions about the criticizing targets from the predetermined computers to the web server.

2. The method according to claim 1, further comprising the steps of:
(e) allowing the web server to receive declaration of intention for and against the criticizing opinions from the predetermined computers disclosing the criticizing opinions in step (d); and
(f) allowing the web server to store the declaration of intention for and against the criticizing opinions and provide it on-line according to the disclosure requests from other inquirers.

3. The method according to claim 1, further comprising the steps of:
(g) allowing the web server to receive personal information on users of the user computers; and
(h) allowing the web server to authenticate the user real names based on the personal information,
wherein step (d), it provides the user real names together with the criticizing opinions.

4. The method according to claim 3, wherein only a portion of the real name is displayed.

5. The method according to claim 3, wherein a portion of the personal information together with the entire name or a portion of the real name is displayed.

6. The method according to claim 3, wherein in step (d), the real name of the user as well as a fact that the real name is true is displayed.

7. The method according to claim 1, further comprising the step of: (i) allowing the web server to transfer the criticizing opinions about the criticizing targets to an address on-line, which is designated by the criticizing targets.

8. The method according to claim 1, further comprising the steps of:
(j) allowing the web server to give a predetermined manager ID to a manager of the criticizing targets through a previous authentication thereof; and
(k) allowing the web server to display a fact that the opinions uploaded through the manager ID are written by the manager, in step (d).

9. The method according to claim 8, further comprising the step of: (l) when the reply opinions of the manager are uploaded through the manager ID, allowing the web server to transfer whether the reply opinions of the manager are uploaded and/or the contents of the reply opinions of the manager to an opinion writer for criticizing via e-mail or SMS using a cellular phone number of the writer.

10. The method according to claim 1, further comprising the step of: (m) allowing the web server to establish the specific targets as the criticizing targets within the sub group according to a reception of an additional request about the specific targets within the sub group from the user computer.

11. The method according to claim 1, further comprising the steps of:
(n) allowing the web server to collect, on the web, the criticizing opinions uploaded on other anti sites thereon
(o) allowing the web server to store the criticizing opinions collected in step (n) corresponding to the criticizing targets,
wherein in step (d), it provides the criticizing opinions stored in step (o).

12. The method according to claim 11, wherein the web server performs the step (n) using a RSS reader.

13. The method according to claim 2, further comprising the step of: (i) allowing the web server to transfer the criticizing opinions about the criticizing targets to an address on-line, which is designated by the criticizing targets.

14. The method according to claim 3, further comprising the step of: (i) allowing the web server to transfer the criticizing opinions about the criticizing targets to an address on-line, which is designated by the criticizing targets.

15. The method according to claim 4, further comprising the step of: (i) allowing the web server to transfer the criticizing opinions about the criticizing targets to an address on-line, which is designated by the criticizing targets.

16. The method according to claim 5, further comprising the step of: (i) allowing the web server to transfer the criticizing opinions about the criticizing targets to an address on-line, which is designated by the criticizing targets.

17. The method according to claim 6, further comprising the step of: (i) allowing the web server to transfer the criticizing opinions about the criticizing targets to an address on-line, which is designated by the criticizing targets.

18. The method according to claim 2, further comprising the step of: (m) allowing the web server to establish the specific targets as the criticizing targets within the sub group according to a reception of an additional request about the specific targets within the sub group from the user computer.

19. The method according to claim 3, further comprising the step of: (m) allowing the web server to establish the specific targets as the criticizing targets within the sub group according to a reception of an additional request about the specific targets within the sub group from the user computer.

20. The method according to claim 4, further comprising the step of: (m) allowing the web server to establish the specific targets as the criticizing targets within the sub group according to a reception of an additional request about the specific targets within the sub group from the user computer.

21. The method according to claim 5, further comprising the step of: (m) allowing the web server to establish the specific targets as the criticizing targets within the sub group according to a reception of an additional request about the specific targets within the sub group from the user computer.

22. The method according to claim 6, further comprising the step of: (m) allowing the web server to establish the specific targets as the criticizing targets within the sub group according to a reception of an additional request about the specific targets within the sub group from the user computer.
